(19) United States
(12) Patent Application Publication
(10) Pub. No.: US 2008/0233324 A1
(43) Pub. Date: Sep. 25, 2008

(54) Sheet Structure and Method for Adhesive Image Transfer

(76) Inventors: Ivan Sou Phong Lee, Arcadia, CA (US); Anahit Tataryan, Temple City, CA (US); Ronald Ugolick, San Dimas, CA (US)

Correspondence Address: FULWIDER PATTON LLP, HOWARD HUGHES CENTER, 6060 CENTER DRIVE, TENTH FLOOR, LOS ANGELES, CA, 90045, US

(21) Appl. No.: 11/908,833

(22) PCT Filed: Nov. 16, 2001
(86) PCT No.: PCT/US2001/043845

§ 371 Date: Sep. 17, 2007

Related U.S. Application Data
(60) Provisional application No. 60/252,174, filed on Nov. 16, 2000.

(51) Int. Cl. B44C 1/17; B32B 33/00

(52) U.S. Cl. 428/40.1; 156/240; 156/538

(57) ABSTRACT

The present invention generally relates to a convenient and aesthetically pleasing way to label a wide variety of objects. The invention includes both an adhesive image transfer sheet assembly and a method for labeling a disc using standard computer equipment typically found in a home or office, such as an ink jet printer. One embodiment of the invention relates to an adhesive image transfer sheet assembly having a backing sheet that is coated with an ink-receptive coating. The coating is activatable to a tacky state by the application of light pressure or heat, and/or by wetting the coating with ink jet ink. The assembly may also be pre-cut to a particular shape, so as to correspond to the shape of a disc, for instance. An other embodiment of the invention relates to a method of labeling an object using the adhesive image transfer sheet assembly. After receiving printing, the ink-receptive coating is placed against the upper surface of the disc, and the user lighty rubs the backing sheet. The light rubbing activates the ink-receptive coating to a tacky state, causing the ink-receptive coating to adhere to the disc. The user can then pull away the backing layer, which may be release-coated for easily separating the backing from the ink-receptive coating. An additional water-resistant layer may be provided on the assembly, in between the ink-receptive coating and the backing sheet, to provide a protective layer over the image after the image has been transferred to the disc.

### RELATED APPLICATIONS

This application claims priority of U.S. Provisional Application Ser. No. 60/252,174 entitled “Structure and Method for Adhesive Image Transfer,” filed Nov. 16, 2000, which is incorporated by reference in its entirety.

### BACKGROUND OF THE INVENTION

General Background and State of the Art: There are a wide variety of applications for labels, such as labeling files, folders, and various storage media (e.g. compact discs and floppy discs), as well as other items, including personal effects. Manufacturers also use labels to label bottles, jars, boxes and the like. Other various packaging, shipping and storage containers require some sort of labeling for identification purposes. A label is typically imprinted with alpha-numeric characters and/or graphics.

Standard label assemblies include a release liner that is coated with a release layer such as silicone. The release liner is removably adhered to a die-cut face stock label that is coated with a pressure-sensitive adhesive. The facestock is typically paper but can alternatively be coated plastic, metallic film, or any of a variety of sheet materials known in the art. In use, one removes the label from the release liner, such as an envelope, packaging or other surface to be labeled, and then applies the label to the substrate that is to be labeled.

Methods have recently been developed that do not require the use of the facestock component that is usually found in label constructions. Instead, text and/or graphics are transferred directly onto a substrate by using ink-receptive, activatable polymers that hold the printed image and that are directly transferred onto a substrate. This “label-less” approach to image transfer prints the image into the activatable, ink-receptive polymer rather than onto a facestock that is coated with adhesive.

U.S. Pat. Nos. 5,969,069 and 6,124,417 to Su et al., which are both incorporated by reference herein, disclose some water-activatable acrylic compositions and various constructions for transferring images onto substrates. Each of the constructions generally includes a polymer layer upon which an ink jet printer prints with water-based ink. The polymer layer becomes tacky within the regions of a wetted printed image, for example, but not in the non-printed regions. While the adhesive is still wet from printing, the adhesive is applied to a substrate and the backing or liner layer is removed.

U.S. Pat. No. 6,277,229 discloses various sheet constructions for transferring images using an ink-receptive adhesive. Some of the adhesives are activatable to a tacky state when imprinted with a water-based ink, such as that from an ink jet printer. The image should be transferred shortly after printing, while the adhesive is still sufficiently hydrated by the inks so that the adhesive is tacky.

The uses to be found for image transfer sheets that do not require a face stock are practically unlimited. One of the many applications is for labeling optical media discs. Optical media discs are sold by the billions every year. Most optical media discs are labeled in some way. Commercially produced optical media discs, such as music CDs sold by major recording companies or DVDs and/or other optical disc media, are mass produced with labeling printed directly on the upper surface of the optical media disc.

There are many optical media discs, however, that are produced in small batches or even individually, for which it is not economical to print with commercial CD labeling equipment. For example, a school child might compile a compact disc containing a variety of graphics and other information from the World Wide Web about a particular topic for a school report. An aspiring musician might compile a CD with a collection of songs that she has composed. A secretary might compile a CD with a year's worth of documents that he has typed, for archiving purposes. In all these situations, it is desirable to have a system for easily preparing a label for a CD. It is preferable to prepare the label using standard home or office personal computing equipment, such as a personal computer and a standard home/office printer. One common type of home/office printer is an ink jet printer.

There are home/office disc labeling kits that are commercially available. One example is illustrated in Avery Dennison's U.S. Pat. No. 5,715,934, which is entitled “CD-ROM Label With Positioning Means,” and which issued on Feb. 10, 1998. The label of the '934 patent is provided as a blank sheet of paper stock that is coated on the back side with a pressure sensitive adhesive. The adhesive-coated paper sheet is mounted to a standard release liner that is coated with silicone or another release coating as known in the adhesive arts. After printing, the user removes the release liner and adheres the printed paper sheet onto the compact disc.

This approach to custom labeling optical media discs has proven very popular and commercially successful. However, the paper-based label is not always as aesthetically pleasing as a disc that has been printed upon commercially. Additionally, the overall success of the application relies in part on the skill of the particular person applying the label. Air bubbles may become trapped between the upper face of the CD and the label when the label is pressed down upon the disc, resulting in an unaesthetic, bumpy label appearance.

Also, a facestock made of paper, for example, also adds thickness to the disc. The additional thickness of the label can cause jamming in certain types of CD-ROM drives, for example.

### INVENTION SUMMARY

The present invention generally relates to a convenient and aesthetically pleasing way to label compact discs, digital video discs, and a wide variety of other products and objects. The invention includes both an novel and beneficial adhesive image transfer sheet assembly and a method for labeling a disc, for example, using standard computer equipment typically found in a home or office, such as an ink jet printer. The present invention may be extended beyond the home or office, and used in a commercial printing and/or labeling setting.

One embodiment of the invention relates to an adhesive image transfer sheet assembly having a backing sheet that is coated with an ink-receptive coating. The coating is activatable to a tacky state when printed upon by aqueous and/or solvent-based inks, and/or is activated by the application of light pressure or heat. The assembly is adapted to receive printing from a printer, such as an ink jet printer, or from other writing devices such as an ink pen.

In one embodiment, the ink-receptive coating is a clear, glossy acrylic emulsion-based polymer film. The film is a co-polymer of HEMA, N-VP, acrylic acid, quaternary amine and other acrylic monomers. A function of the ink-receptive coating is to absorb and fix aqueous dye and pigment-based inks. The coating can be pigmented to enhance the opacity and/or tint the film. After printing, the ink-receptive coating will become tacky and can stick to a variety of surfaces.

Various printers may be used to print the image transfer sheets including, but not limited to standard home/office ink jet printers and wide-format ink jet printers. Wide-format printers, such as wide format ink jet printers, are known in the art and are available commercially from Hewlett-Packard Corporation of Palo-Alto, Calif. Additional printing methods include flexographic printing, brushing, spraying dipping and coating, for example. The adhesive image transfer sheet may also be pre-cut or perforated to a particular shape, so as to correspond to the shape of a disc, for instance.

Furthermore, provisions for air egress are made in certain embodiments of the present invention. For example, a pattern or textured surface may be formed on the image-holding layer to provide an escape route for air that is trapped between the image-holding layer and the surface that is being labeled. The “escape routes” allow air to escape from underneath the image-holding layer so that bubbles do not form on the transferred image-holding layer. Alternatively, non-adhesive material may be embedded into the ink-receptive adhesive layer to provide routes for air egress.

In addition to the image-holding layer, other layers, such as one or more water resistant layers, may form part of the adhesive image transfer sheet assembly. For example, a water-resistant layer may be provided in between the image-receptive layer and a backing sheet, which may optionally be release-coated with silicone or another release coating known in the art. One embodiment of a water-resistant layer is a clear, glossy polymer film, comprised of a blend of polyacrylic based emulsion, nitrile rubber emulsion and polyethylene based emulsion. The water-resistant layer provides a protective film over the image. Other embodiments of a water-resistant layer may be tinted to provide the image with a tinted or pigmented appearance when viewed through the water-resistant layer.

Another embodiment of the invention relates to a method of labeling a disc using an adhesive image transfer sheet assembly. After receiving an image printed with ink, the ink-receptive coating is allowed to dry. The image-holding layer is then placed against the upper surface of the disc, and the user lightly rubs the backing sheet. The light rubbing may activate the ink-receptive coating to a tacky state, causing the ink-receptive coating to adhere to the disc. The user can then pull away the backing (or liner) layer, which may be release-coated for easily separating the backing from the ink-receptive coating. An additional water-resistant layer may be provided on the assembly, in between the ink-receptive coating and the backing sheet, to provide a protective layer over the image after the image has been transferred to the disc. Additional layers may also be provided as part of the adhesive image transfer sheet assembly which provide water resistance to the transferred image. Formulations and the positions of such layers are further detailed below.

Alternatively, the image transfer sheet may be applied to the disc shortly after the image holding layer is printed and rendered tacky in the printed areas by the liquid ink. The user may lightly rub or press the backing sheet to remove air bubbles and creases, but the adhesive is already activated in the printed areas by the wet ink.

Various embodiments of the present invention may have particular advantages. For example, certain embodiments of the present invention are well suited to low-thickness labeling, in which there is no facestock that is transferred onto the object, thereby reducing the thickness of the image. Cost-of-Production savings may result from eliminating the facestock that is used in typical labels.

There are also aesthetic advantages to embodiments of the present invention. With a label having a facestock that transfers onto the object, the facestock is visible even in areas where there is no printing. In contrast, embodiments of the present invention may be clear in areas where there is no printing, which typically has more aesthetic appeal than unprinted facestock.

These and other features are examples of particular embodiments of the invention, but the invention also includes various other features and embodiments, as will become apparent from the following Detailed Description, the Claims, and the Drawings.

### BRIEF DESCRIPTION OF THE DRAWINGS

FIG. 1 is a cross-sectional view of one embodiment of an image transfer sheet;

FIG. 2 illustrates one example of a process for printing an image on an image transfer sheet and then applying the image to a window;

FIG. 3 illustrates one example of a process for printing an image on an image transfer sheet and then applying the image to a bottle as a label;

FIG. 4 is one embodiment of an image transfer sheet that is adapted for labeling a compact disc;

FIG. 5 is an alternative embodiment of an image transfer sheet after indicia and/or graphics has been printed onto the sheet;

FIG. 6 is a detail view of a tab of the sheet of FIG. 5;

FIG. 7 illustrates a generally circular portion of the image transfer sheet with handling tabs, all having been removed from the backing sheet and ready to be mounted in an image transfer apparatus or directly applied to a surface of a compact disc;

FIG. 8 illustrates a compact disc image transfer apparatus with the image transfer sheet of FIG. 7 mounted thereon;

FIG. 9 illustrates the compact disc labeling apparatus of FIG. 9 with a compact disc being mounted thereon for labeling by image transfer;

FIG. 10 is a cross-section taken about Line 10-10 of FIG. 9 when the compact disc has been fully depressed to effect the image transfer onto the compact disc; and

FIG. 11 is a bottom view of the compact disc image transfer apparatus in the configuration of FIG. 10.

### DETAILED DESCRIPTION OF THE PREFERRED EMBODIMENTS

The present invention relates to transferring an image onto any of a wide variety of substrates and image transfer sheet assemblies for doing so. In general, the image transfer happens by first imprinting an image into an ink-receptive polymer and then transferring the polymer to a surface of a substrate. Particular embodiments of the present invention may transfer images to various objects and surfaces that are commonly found in offices and households. Embodiments of the image transfer sheets can image, customize and/or personalize objects that cannot normally be printed with a standard home or office ink jet printer.

For example, in an office or school setting, the present invention includes embodiments for transferring text and/or graphics to tabs and dividers, sheet protectors, binders, report covers, name tags, signs, lunch boxes, presentation boards, props, bulletin boards, chalk/dry erase boards, and displays, among many other things. In a home setting, the present invention provides embodiments for transferring printed text and/or images to mirrors and windows, walls, tiles, refrigerators, file cabinets, files, computer screens, cards, boxes, envelopes and numerous other surfaces.

Many other applications can be imagined. With respect to arts and crafts, a user may transfer an image onto decoupage, photo albums, scrap books, needle point, ornaments, glasswork, tiles, coasters, mat placements, wall hangings, T-shirts, fabric designs, banners, ties, calendars, pillowcases, and aprons. With respect to room decor, images may be transferred onto mirrors, windows, walls, tiles, doors, refrigerators, file cabinets, and computer screens. For gifts and special occasions, image transfer may be used to customize gift wrap, gift boxes, gift bags, cards, envelopes, candles, balloons, magnets, frames, banners, table clothes, party favors, party decorations, over-sized cards and over-sized envelopes, and jars. Examples of using image transfer for identification include labeling optical media discs, tabs, dividers, sheet protectors, binders, report covers, name tags, lunch bags, lunch boxes, and signs.

Image transfer sheets of the type described below can also be used in advertising, such as in customizing hats, puzzles, cups, mugs, key chains, pens, sports bottles, mouse pads, candles, and magnets. Image transfer may also be useful in color coding and organizing objects. Numerous other examples may be imagined, and the foregoing list is merely for purposes of illustration, and not of limitation.

The inventors have also discovered that embodiments of the image transfer sheets that this Detailed Description describes have utility even when not first printed with ink. For example, an image transfer sheet may be used to reduce transmission of electromagnetic radiation through a window. It is well-known that a room can become rather hot when sunlight is permitted to stream through a glass window into the room. This is particularly true in hot and/or sunny climates. Image transfer sheets can be used with or without printing on the sheet to reduce the radiation from the sun or other sources that causes the room to heat up.

For instance, one method of reducing transmission of electromagnetic radiation through a window includes wetting the image retaining layer of an image transfer sheet. The image transfer sheet is placed against a window, with the image retaining layer against a surface of the window. The image retaining layer is adhered to the window, and the user removes the backing sheet. The window will continue to transmit light, but the image retaining layer reduces the electromagnetic radiation that causes the room to heat up.

The user may first wish to cut the image transfer sheet to fit the window, and will normally do so before wetting the image transfer layer. The user may also print onto the image retaining layer before applying it to the window. For example, the user might print a stained glass pattern onto the image retaining layer in order to give the window a stained glass effect.

As a further alternative, with certain embodiments of the image transfer sheet, the user may skip the step of wetting the image retaining layer. Instead, the user adheres the image retaining layer to the window by placing the sheet against the window and lightly rubbing the backing sheet, so as to generate heat and/or pressure that activates the image holding polymer to a tacky state.

Image transfer sheets for use as window films may incorporate an additive to the image holding polymer that reduces the surface tackiness of the polymer. This can aid the user in positioning the sheet onto the window by preventing the image holding layer from adhering too firmly to the window until the user has the sheet properly positioned. The reduced surface tackiness also allows the user to smooth out creases and/or air bubbles so that the image retaining layer lays flat on the window. Suitable additives for reducing surface tackiness are discussed below.

The image retaining layer may also have a fine pattern on its surface to allow air to egress as the layer is placed against the window surface. Patterns for allowing air to egress from a surface of a film are known in the art.

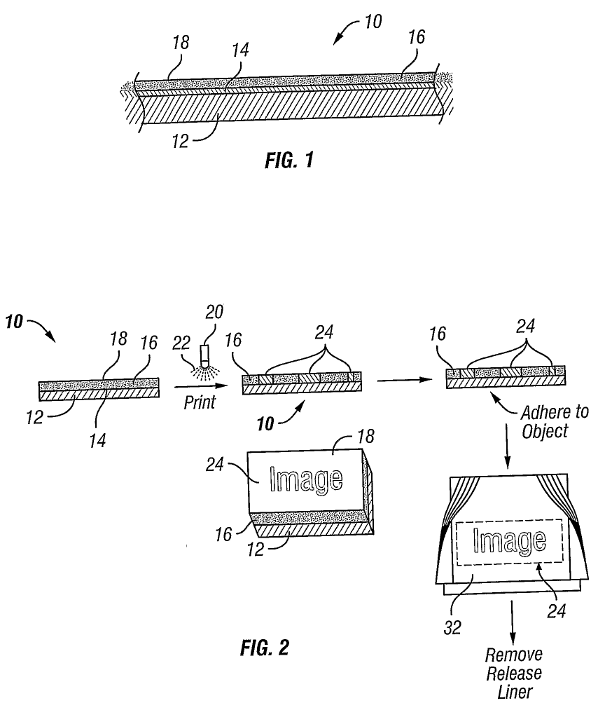

Considering now specific embodiments of an image transfer sheet, FIG. 1 illustrates one embodiment of a sheet for adhesive image transfer. The sheet 10 has a backing sheet 12 with a release coating 14. An image holding layer 16 (which may alternatively be referred to as an “image receptive layer,” “ink receptive layer,” or the like) provides a printing surface 18. The image holding layer 16 is typically ink-receptive prior to being printed, particularly with respect to ink found in ink jet printers. Preferably, the image holding layer 16 is receptive to ink commonly found in ink jet printers, such as aqueous and glycol-based ink jet printer inks.

An exemplary image holding layer 16 may include a polymer such as described in detail in U.S. patent application Ser. No. 556,236, which we incorporate by reference in its entirety, and which was filed on Apr. 24, 2000. The Detailed Description of that application is appended hereto as Appendix A. Generally speaking, the polymer is receptive to water-based inks, such as those that are commonly used in ink jet printers. The polymer becomes tacky when exposed to water or heat and/or pressure. The heat required to activate these exemplary polymers may be as low as the heat that is provided by one's fingers (body heat) when the image transfer sheet is applied to a surface and the flexible liner/backing is rubbed to activate the ink receptive adhesive and adhere the desired image to the surface.

By way of overview, one embodiment of the polymer is an emulsion that is produced as the reaction product of a monomer mixture comprising an alkyl (meth)acrylate, a quaternary amine (meth)acrylate, a hydroxyalkyl (meth)acrylate, an N-vinyl lactam, an ethylenically unsaturated carboxylic acid, and a fluorinated (meth)acrylate. Additionally, a hard monomer and/or an ethoxylated (meth)acrylate monomer may be provided. However, modifications may be made. For example, an excellent image-holding polymer may be formulated as in Example 3 of Appendix A, except that hydroxyethylmethacrylate is replaced with hydroxyethylacrylate at a monomer concentration of 33%, the methylacrylate is reduced to 3.3%, and the methylmethacrylate is omitted and replaced with butyl acrylate.

The polymer emulsion may be produced under vigorous mixing, and preferably in the presence of a plurality of surfactants to further ensure good mixing. In one preferred embodiment, the polymer emulsion is made by a sequential polymerization reaction of two different monomer mixtures. For such a sequential polymerization reaction, the first monomer mixture is allowed to partially react before the second monomer mixture is added to the reactor. Improved properties for the resulting polymer coating result when the second monomer mixture has a lower amount of ethylenically unsaturated carboxylic acid than the first monomer mixture. In particular, when such a sequential polymerization reaction is used, the resulting polymer emulsion has a lower viscosity at higher solids concentration than would otherwise be achieved if a single monomer mixture were reacted. By having a lower viscosity at a higher solids content, the polymer emulsion is far easier to handle. U.S. patent application Ser. No. 556,236 and Appendix A hereto describe the various formulation of the polymer in greater detail.

The polymer may be combined with other components, to provide favorable physical properties. For example, Synthomer S-6000 is a nitrile rubber co-polymer that is available from Synthomer GmbH that may provide the polymer with flexibility. In one alternative embodiment of the present invention, 94.028 parts by weight on a dry basis of a polymer according to U.S. patent application Ser. No. 556,236 is combined with 5.972 parts by weight on a dry basis of Synthomer 6000 to form the ink absorbing layer. Numerous other variations fall within the scope of the invention.

Another embodiment of a suitable polymer is formed by combining a polymer as described in U.S. patent application Ser. No. 556,236 with a repulpable, pressure sensitive adhesive. One exemplary and suitable embodiment of such a repulpable, pressure sensitive adhesive is described in International Application Number PCT/US98/21174, which was published on 22 Apr. 1999 as WO99/19415 and is herein incorporated by reference in its entirety. For example, a suitable polymer may be formed by combining 66.19 parts by weight on a dry basis of a polymer according to the disclosure of U.S. patent application Ser. No. 556,236, with 33.801 parts by weight on a dry basis of an adhesive according to the disclosure of WO99/19415, for a total of 100 parts by weight on a dry basis.

The image holding layer 16 may include a cross-linker to provide certain desirable characteristics. For example, a polymer as described in Appendix A may be combined with a cross-linker. The cross-linker may serve to reduce the tackiness of the image holding layer 16 until the layer 16 is activated with heat and/or pressure to a more tacky state, or is activated by the liquid ink itself. This feature permits the user to position and reposition the image transfer sheet on a substrate prior to fixing the image in place on the substrate. The user is also able to gradually apply the image holding layer 16 to a substrate while smoothing out air bubbles and/or wrinkles in the layer 16 as it is being applied. The reduced tackiness also facilitates reel-to-reel processing of webs that are coated with the image holding polymer, without the surface of the polymer getting stuck to the underside of the immediately-adjacent backing sheet on the roll.

The cross-linker may be, for example, a quaternary amine type of polymer. Additionally, it is believed that a polymer base identified as SRI 13796 from Cyance Corporation of Menlo Park, Calif. (currently providing company information on the Internet at http:/www.cyance.com, and which is related to SRI International, also of Menlo Park, Calif.), acts as a cross-linker when added to the image-holding polymer. In particular, the inventors have discovered that the surface tackiness of the image-holding polymer is reduced when the polymer base is added. The reduction in surface tackiness improves applicability of the image-holding layer to substrates, in that image-holding layer is less likely to crease or bubble as it is being adhered to the substrate. The user is also better able to reposition the image transfer sheet on the substrate, without the image-holding layer prematurely bonding to the substrate. The sheet is also better suited for smoothing out air bubbles and creases during application.

Cyance Corporation holds rights to a number of patents, including U.S. Pat. Nos. 6,291,023 and 6,241,787, both of which are incorporated by reference herein.

For image transfer, the cross-linker is typically provided at between 0.5% and 1.0% on a dry weight basis. For special applications in which the image is not to be transferred, but where image quality is paramount, the amount of cross-linker may be increased to, for example, between approximately 2.5% and 10.0% on a dry weight basis.

FIG. 2 illustrates steps in a process of printing an adhesive image transfer sheet 10 and an ink jet printer, and applying the printed image to the surface of a window. The sheet 10 is fed into an ink jet printer 20, which prints ink jet ink 22 onto the sheet 10. The ink jet ink 22 is typically an aqueous ink, although it may alternatively be a glycol-based ink or other type of ink jet printer ink commonly used by manufacturers of ink jet printers. The ink jet printer 20 prints an image 24 onto the sheet 10. The image 24 may include text and/or graphics, such as text messages, photographs, drawings, and the like.

After the image is printed upon the sheet 10, the sheet is typically allowed to dry for at least several minutes. The user then presses the surface of the sheet 18 against the surface of the window 32. If the image 24 has been allowed to dry, the user activates the image holding layer 16 to a tacky state by lightly rubbing on the backing sheet 12, thereby generating pressure and heat. If the image 24 is still wet and the imaged area is tacky after having been activated by the liquid ink, light rubbing may not be needed to apply the image-holding layer to the substrate but may still be helpful in removing air bubbles or creases. Once the image holding layer adheres to the substrate and any undesired bubbles or creases are eliminated, the user removes the backing sheet.

Considering this further, it should be noted here that although in one embodiment of an image transfer sheet, the image holding layer is activated to a tacky state by way of heat and pressure, alternative types of adhesives and/or methods of applying the adhesive to a substate may be employed. For example, adhesives that are water activated may be used in conjunction with an aqueous ink jet printer ink. After printing, the printed areas of the sheet are then tacky, and the image may be applied to the substrate shortly after printing to the substrate, without allowing the printed ink to dry. In this way, light rubbing is not necessary to activate the image holding layer to a tacky state. Nevertheless, even with an image holding layer that is primarily activated by the ink jet printer ink, the user may wish to apply light rubbing to the backing sheet in order to remove bubbles that would otherwise become trapped in between the image holding layer and the surface of the substrate, or generally to smooth the image onto the substrate. Consequently, the user may wish to rub the backing sheet for purposes other than activating the adhesive.

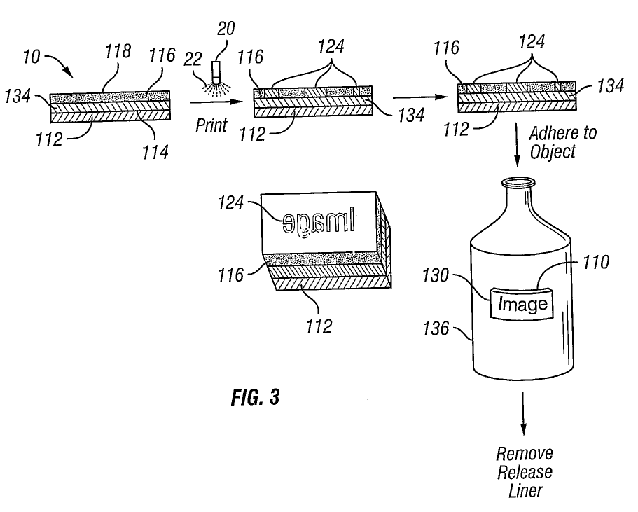

It is noted that the ink jet printer will typically be used in conjunction with computer software for composing and/or generating the image to be printed. In the example of FIG. 2, the image is printed onto the sheet precisely as it will appear when applied to a window. That is, in FIG. 2 the image includes text that reads “Image.” The word “Image” is printed exactly as it will appear on the window, when the printed sheet is applied on the surface of the window opposite to the surface through which the user will be looking. That is, if the image is to be viewed from, say, the outside of the window and the image is to be applied to the inside of the window, the word “Image” should be printed on the sheet exactly as it is to appear on the window. However, for some applications, it is desirable to print the image backwards on the image transfer sheet for some applications. For example, turning to FIG. 3, the image 124 is printed onto the image transfer sheet in reverse. The printed image may be applied as a label to the exterior of a bottle, for example, and the text will appear on the bottle in an orientation that is proper for one to read.

Considering FIG. 3 further, an image transfer sheet 110 is provided having at least three distinct layers. Layer 112 is a release coated backing sheet. Layer 134 is a water repelling layer, and the upper layer 116 is an image holding layer as described in the embodiment of FIG. 2. One purpose of the water repelling layer 134 is to protect the image after printing from water, dirt, and/or other things that could damage the image over time. For example, to use an image transfer sheet for the purpose of labeling the exterior of a bottle, it may be important in some applications that the transferred image is resistant to water.

The water-resistant layer may be a clear, glossy polymer film, comprised of a blend of polyacrylic-based emulsion, nitrile rubber emulsion and polyethylene-based emulsion. The water-resistant layer provides a protective film over the image. Other embodiments of a water-resistant layer may be tinted to provide the image with a tinted appearance when viewed through the water-resistant layer. Alternatively, the water-resistant layer may be mixed with metallic flakes or other materials to provide special effects to the image when viewed.

One embodiment of a water-resistant layer is a film derived from an acrylic based emulsion. A formulation for one such coating is as follows:

| Acrylic Based Emulsion | Parts by Weight (Dry on Dry Basis) |
|---|---|
| Base Polymer | 75.70 |
| Acrylic Emulsion Coating | 5.80 |
| Jonwax-28 | 8.20 |
| Synthomer S-6000 | 10.30 |
| Total | 100.00 |

In the foregoing table, Jonwax-28 is a wax that is commercially available from S. C. Johnson and Son Limited, of Brantford, Ontario, Canada. The wax serves to provide the emulsion with water resistance. Synthomer S-6000 is a nitrile rubber co-polymer that is available from Synthomer GmbH that provides the emulsion with flexibility.

In one particular embodiment, the coating has a pH of between about 7.0 and about 8.2. The coating has total solids of 45.50±0.5%, and a viscosity of 2,000-3,500 cps.

In one procedure for making a clear film coating, the pH of the base polymer is first checked to ensure that it is 7.0 or greater. Jonwax 28 is then added, followed by Synthomer S-6000 under good agitation for 15-20 minutes to avoid trapping air into the compound. The solids and viscosity are adjusted using de-ionized water, and the compound is then filtered through a 55 micron filter.

One example of a suitable base polymer is prepared as follows. A soap solution is prepared having components as follows:

| Soap Solution | Parts By Weight |
|---|---|
| De-ionized Water | 99.09 |
| T.S.P.P. (59.7%) | 0.27 |
| OT-75 (75.0%) | 4.25 |
| Disponil FES-77 (32.50%) | 18.06 |
| Surfynol 485W (63.7%) | 5.21 |
| Total | 126.88 |

In the foregoing table, Surfynol 485W is a nonionic surfactant that functions as a wetting agent. It is available from Air Products and Chemicals, Inc of Allentown, Pa. TSPP is an abbreviation for tetra sodium pyro phosphate. OT-75 is an abbreviation for Aerosol OT 75% Surfactant, which is available from VAN WATERS & ROGERS LTD of Richmond, British Columbia. Disponil FES-77 is a surfactant that is available from Cognis Corp. of Cincinnati, Ohio.

A monomer mix is gradually added to the soap solution under good agitation to form a stable monomer pre-emulsion and is held for delay addition. A catalyst solution is prepared having components as follows:

| Catalyst Solution For Delay Addition | Parts By Weight |
|---|---|
| De-ionized Water | 41.44 |
| K-Persulfate | 1.06 |
| Total | 42.50 |

The potassium persulfate (“K-Persulfate”) serves as an initiator for the polymerization. Once the catalyst solution is prepared, the catalyst solution is held for delay addition.

A standard reactor of the type known in the art is purged with N₂. A reactor charge having the following composition may be used:

| Reactor Charge | Parts By Weight |
|---|---|
| De-ionized Water | 219.41 |
| Disponil FES-77 | 2.66 |
| K-Persulfate | 1.06 |
| Total | 223.13 |

The reactor charge is heated to approximately 78° C. at moderate agitation. At approximately 78° C., the potassium persulfate is added to the reactor. It is mixed for 3-5 minutes. The monomer pre-emulsion is added at approximately 3.07 parts by weight/minute for approximately 180 minutes.

Approximately 18 minutes after the pre-emulsion is added, the catalyst is added at 0.23 parts by weight/minute for 185 minutes. Agitation is increased as necessary. The reaction temperature is held for approximately one hour between 80 and 85° C. after completion of the catalyst addition. The residual monomers are then checked and, when the residual monomers are below 0.05%, the batch is gradually cooled to 35° C.

As the batch cools, an NH₃ solution, a defoamer, a biocide and de-ionized water are added, in approximately as follows:

| NH₃, Defoamer, Biocide and H₂0 Rinse | Parts By Weight |
|---|---|
| 19% NH3 Solution | 5.00 |
| Defoamer (Drewplus L-191 (100.0%)) | 0.50 |
| Biocide (Kathon LX (1.5%)) | 0.30 |
| De-ionized Water | 25.74 |
| Total | 31.54 |

When the temperature of the batch is at 50° C., the 19% NH₃ solution and defoamer are added. At 40° C., the biocide is added. The rinse water is used to adjust the total solids and the viscosity. The mix is filtered through a 55 micron filter, and the pH, solids, viscosity and residual monomers are checked.

One specific embodiment of the emulsion may have the following specifications. The pH may be about 7.00-7.80. The total solids may be 52.50±0.5%. the grit may be less than 20 parts per million (ppm) on a 55μ filter. The viscosity may be 1,000-3,500 centipoise (Brookfield LVT #3 SPINDLE/30 RPM/25° C.). Methods for the manufacturing of image transfer sheets is further detailed in U.S. patent application Ser. No. 6,277,229, which is incorporated by reference into this patent application.

FIG. 3 illustrates a process in which an image is printed upon an image transfer sheet and is transferred to a bottle to form a bottle label. In the first step, an image transfer sheet 110 is provided, such that the image transfer sheet has a backing layer 112 that is release coated with release coat 114, a water resisting layer 134, and an image holding layer 116. The exposed surface of the image holding layer 116 forms a printing surface 118. The image transfer sheet 110 is fed into an ink jet printer 20 that prints an image with ink 22 onto the surface of the image holding layer 118.

The printed image is represented in FIG. 3 by reference numeral 124. The image 124 is typically printed in reverse, so that once it is applied to the bottle or other substrate, the text and/or graphic will be properly oriented for a user to read. After printing, the user typically allows the image holding layer to dry, and then applies the image holding layer to the bottle by placing the surface 118 of the image holding layer against the exterior surface of the bottle 136. The user then lightly rubs and/or presses the backing layer 112 to remove bubbles of air in between the image holding layer 116 and the surface 136 of the bottle.

In some embodiments of the invention, the light rubbing action also serves to activate the adhesive to a tacky state. However, in other embodiments, the adhesive is sufficiently activated by the ink jet ink that rubbing is not needed for the purpose of activating the adhesive, but may optionally be employed anyhow to remove air bubbles or creases in the image holding layer.

Generally, once the image holding layer is properly adhered to the surface of the substrate, the backing layer is peeled away so that the image is visible. There can be exceptions, however, such as when the image is to be applied on the inside of a glass window and the backing layer is left on the image transfer assembly to serve as a visual background for the image. The backing layer may even be colored, for example, to provide a colorful background to the image.

The image holding and water repelling layers are typically coated onto the backing layer, although other known methods of applying layers to a backing sheet may be used. Regarding coat weights, in one embodiment the coat weight of the image-holding layer may be as low as 15 g/m², but the coat weight will more typically be between 20-30 g/m². For special applications such as outdoor signage, the coat weight may be as high as 25-50 g/m². Generally speaking, the printed ink will dry more quickly as the coat weight of the image-holding layer is increased.

In one embodiment, the coat weight of the water-repelling layer may be as low as 6 g/m², and is more typically between 10 and 15 g/m². For heavy-duty applications such as outdoor signage, the coat weight of the water-repelling layer may be as high as 20-25 g/m². Generally, the water resistance of the water-repelling layer will increase as the coat weight of the water-repelling layer increases.

The coat weight of the release coating on the release liner will vary depending on the particular type of release liner to be used. Many different release liners are known in the art and are suitable for use with image transfer sheets of the present invention. As one example, a silicone release coating may be applied such that the coating has a thickness of between 0.7 g/m² and 2.0 g/m², and more typically between 1.0 and 1.5 g/m².

Another aspect of image transfer sheets relates to the smoothness of the release liner. The texture of the surface of the liner may transfer in some embodiments to the surface of the image transfer sheet. So, for example, a very smooth release liner such as a silicone-film liner tends to leave behind a glossy finish to the exposed surface of the image transfer sheet when the release liner is removed. On the other hand, a release liner having a surface that is somewhat rougher can result in a transferred image that is less glossy, such as a matte finish. Consequently, the product designer can vary the Sheffield smoothness of the liner to vary the glossiness of the transferred image. Similarly, a pattern may be formed on the surface of the release liner by way of score lines or protrusions or other surface irregularities, in order to impart a specific pattern to the surface of the image.

The surface of the image transfer sheet that is ultimately applied to the substrate may be provided with a surface pattern in order to permit air to escape from between the sheet and the substrate. This can be particularly useful in preventing surface bubbles and creases in the transferred image. The pattern may be a standard hexagonal micropattern known in the art for providing air egress. The micropattern may be very fine, such that it is not visible to the unaided eye.

Considering now optional additions to the image transfer sheets, a pigment may be added to the image-retaining layer in order to color the layer or to make it translucent. For example, white TiO₂ may be blended into the image-retaining layer to provide better contrast to the printed image. Generally speaking, the TiO₂ may be mixed in at a concentration of 1%-5% without interfering with the penetration of the ink into the image-holding layer. The TiO₂ can serve to improve contrast of the printed image.

Similarly, a colored pigment such as iron oxide may be used to tint the image-retaining layer yellow. Substances for providing specific colored tints to films are known in the art. Other substances, such as glitter and a variety of other substances known in the art may also be added to provide particular effects.

One particular application for image transfer sheets according to the present invention is for labeling optical media discs. Generally speaking, a compact disc (or “CD”) is normally circular in shape, although optical media discs in rectangular and other shapes are also possible. For optical media discs that are round, an image transfer sheet that has a round portion that corresponds in shape to the round optical media disc may be employed, although image transfer sheets may be shapes other than round and still successfully transfer an image onto a compact disc. In most embodiments, though, when the image that is printed upon the image holding layer is transferred to the compact disc, the transferred image holding layer has a round shape that corresponds to the disc onto which it is being transferred. For compact discs that are shapes other than round, such as rectangular optical media discs, the optical media disc adhesive image transfer sheet may have a portion that corresponds to the shape of the optical media disc to be labeled.

It is noted that image transfer sheet that do not physically have a round portion corresponding in shape to the optical media disc may be employed to transfer a round imaged portion onto the optical media disc. For instance, a large rectangular sheet may be used, but only a circular pattern is printed onto the sheet, thereby activating only a circular area of the image-holding layer. Alternatively, a non-circular pattern may be printed on a non-circular sheet, but only a circular portion of the image holding layer transfers when the pressure and/or heat generated by the user rubbing the backing layer extends only in the circular are defined by the disc. Other variations are possible.

Optical media discs have a circular shape and have a central circular opening. The circular opening can be, for example, a full-face type of (narrow) opening corresponding to the diameter of the center opening of the disc or can be a standard diameter such as 1⅝ inch. A sheet for image transfer onto an optical media disc circular will typically have a portion corresponding in shape and diameter to a standard optical media disc. For example, the diameter of the optical media disc may be 4½ inches, although other optical media discs have different standard diameters.

One example of an image transfer assembly for labeling an optical media disc can has one or preferably two diametrically opposed tabs extending out from the label and attached thereto. The image transfer assemblies have an image holding layer and, optionally, a water-resistant layer as illustrated in FIG. 3. The assembly is backed with a liner sheet, which is normally releasable from the image holding layer and the optional water resistant layer. The portion of the assembly that will label the optical media disc is outlined by weakened separation lines (die-cut, perforated, scored and other) in the liner sheet.

After the sheet has passed through a printer or copier and the desired indicia and/or graphics printed on the portions of the sheet coated with an image-holding layer, the tabs are pushed or pulled up and grasped to pull the optical media disc labeling portion off of the sheet. The user can then grasp the other opposing tab, or can grasp and pull both tabs at the same time. By grasping the two tabs, the user does not contact any surface of the printed image holding layer. The user can then position the exposed surface of the printed image holding layer against the surface of the optical media disc to be labeled, lightly rub the backing sheet to force any air trapped between the label and the surface of the optical media disc to egress, and then remove the backing sheet.

Alternatively, she can position the image transfer assembly on a label applicator device. In one embodiment, the image transfer assembly is positioned with the side of the sheet that is coated with image holding layer facing up, and the tabs on the image transfer assembly hooked into place on the applicator. The disc is then pressed down on a center post of the device into contact with the image holding layer. The disc with the image holding layer (and optional water repelling layer) adhered thereto can be removed from the device.

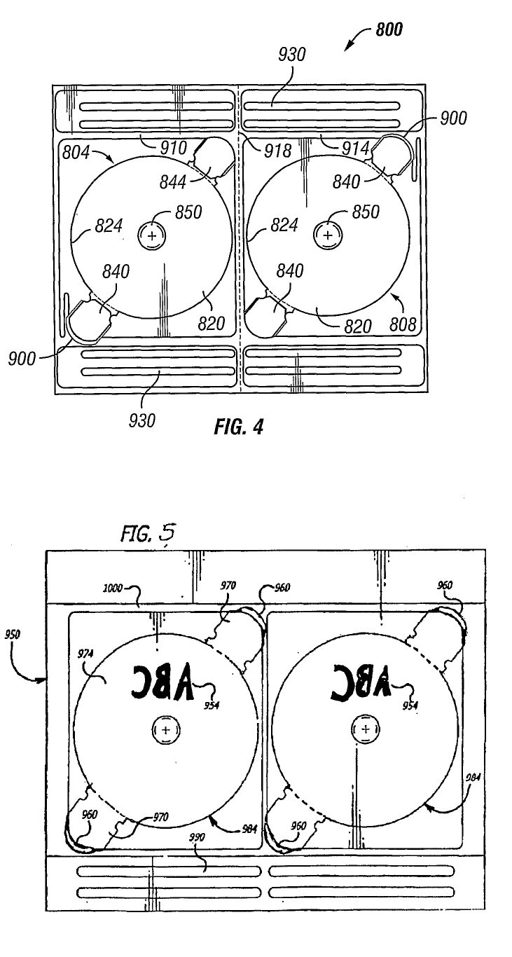

Referring to FIG. 4, one embodiment of an image transfer sheet for transferring an image to an optical media disc is shown generally at 800. The sheet includes two side-by-side image transfer assemblies 804, 808. The assemblies are identical except that one is rotated one hundred and eighty degrees relative to the other one. Both include circular image transfer portions 820, with the outside circumferences defined by die-cut lines 824 through the release liner around the entire perimeter. The center hole 850 is formed by a die-cut line, and the hole can either be a full face (small) hole or a standard larger hole.

The tab portions 840, 844 of the label assemblies are formed by die-cut lines having ties and cuts through the facestock sheet. The die cuts may extend about the entire circular portion of the disc, so that the image-holding layer separates cleanly from the sheet even at the base of the tabs. Each of the tabs has a pair of opposing side notches 890. These notches are provided to help position and hold the labels in place on label applicator devices, as will be shown and discussed later in this disclosure. The notches can have a central tie portion.

Openings 900 may be cut from the sheet to provide crescent-shaped openings that assist the user in removing the tabs and circular disc-labeling portion from the assembly. Openings 900 may be cut by any of the standard methods for cutting such openings that are known in the art, such as die-cutting or laser-cutting. The assembly may also include a plurality of image transfer areas 930 for labeling the spine of an optical media disc case, or any of a variety of other shapes and sizes of patches of transferable image holding layer.

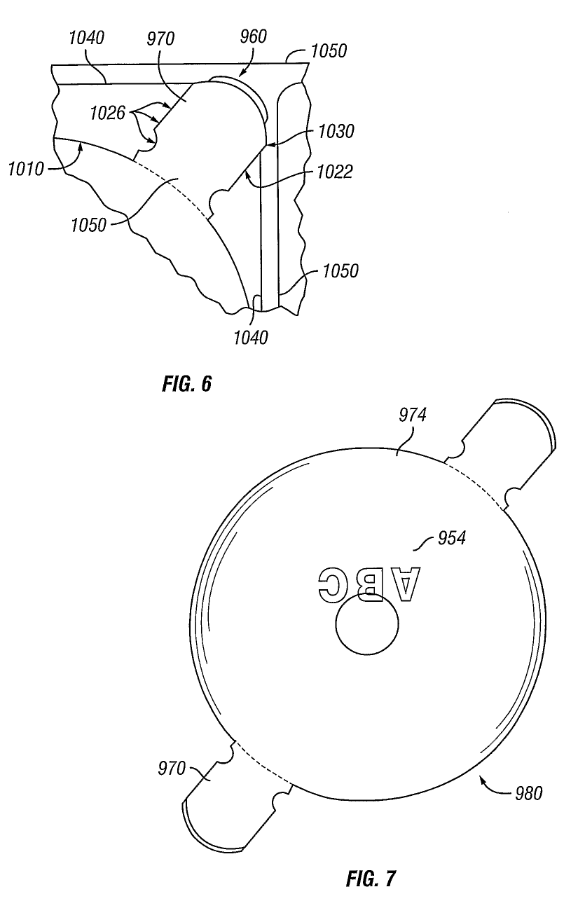

FIG. 5 illustrates an alternative embodiment in which crescent-shaped openings are cut from the area at the end of each of the four tabs. FIG. 6 is a detail view of the opening 960 at the end of one of the tabs. In use, after the image transfer sheet is printed, the user inserts her finger or a finger nail into one of the crescent-shaped openings 960 and pulls up on the respective image transfer assembly, grasping the respective tab 970 from the front and back. The circular disc-labeling portion and associated tabs separate from the assembly along the lines of weakness, which may be perforations, microperforations, scorelines or other lines of weakness known in the art. The user may grasp the opposing tab on both sides thereof between the fingers of her other hand. The image transfer assembly 980 is then as depicted in FIG. 7, ready for insertion on a label applicator device, or for a direct application onto a disc without an applicator device.

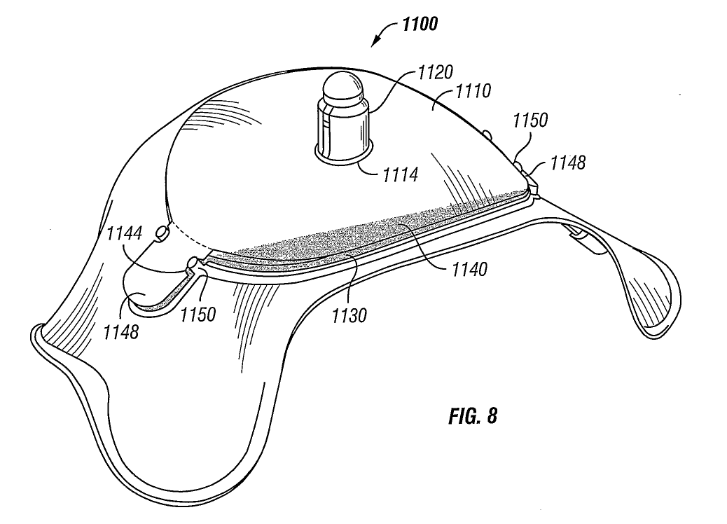

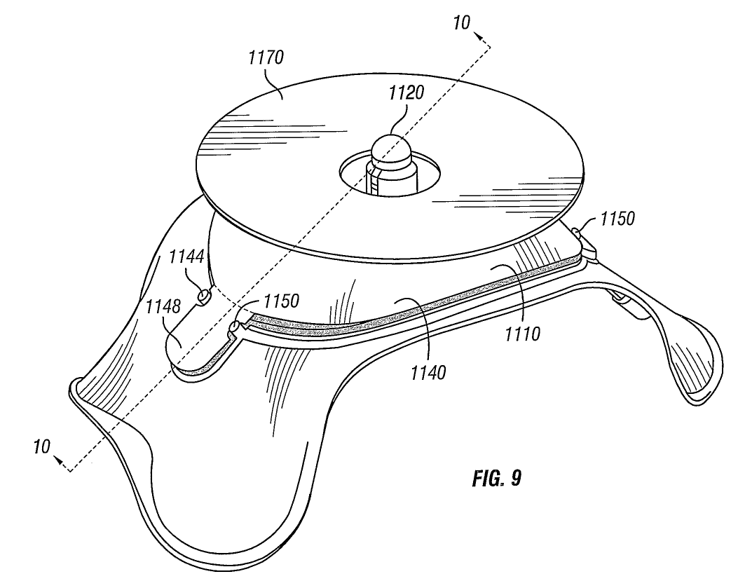

FIG. 8 is a perspective view of an applicator device shown generally at 1100 with an image transfer assembly 1110 of the present invention in position thereon. It can be seen that the assembly 1110 is fitted via its central hole onto the central post assembly 1120. The image transfer assembly is held on the soft curved support surface 1130 of the device, with the image holding layer side 1140 facing up, by the positioning the tab notches 1144 of the tabs 1148 onto the upright device pins 1150. With the image transfer assembly secured to the applicator, the disc 1170 is positioned on the center post 1120 as shown in FIG. 9 and pressed down onto the image transfer assembly 1100, thereby adhering the image to the disc. That is, the disc 1170 is shown in FIG. 9 in a rest position on the post assembly, ready to be manually pressed down onto the adhesive surface of the image transfer assembly 1170.

Generally speaking, applicator 1100 includes a flexible body member formed of polypropylene, polyethylene or other flexible plastic compounds. The applicator body member has “feet” at both ends thereof and an arched central portion extending between the feet. A post assembly shown generally at 1120 extends up from the center of the top of the body member and is integrally formed therewith. The applicator body member slopes in longitudinal directions away from the post assembly 1120 and can be shaped similarly to a top portion of a bridge. (Less preferably, the body member can be shaped so that its top label support surface has a dome shape). The top sloping surface of the body member 1106 forms a support surface for an image transfer sheet.

A soft pad 1130 (FIG. 8) is preferably disposed on the surface and defines the contact surface for the image transfer sheet. The pad 1130 can be a urethane foam, rubber or other compound. It preferably has a bottom pressure-sensitive adhesive layer to adhere to the support surface of the applicator body 1106.

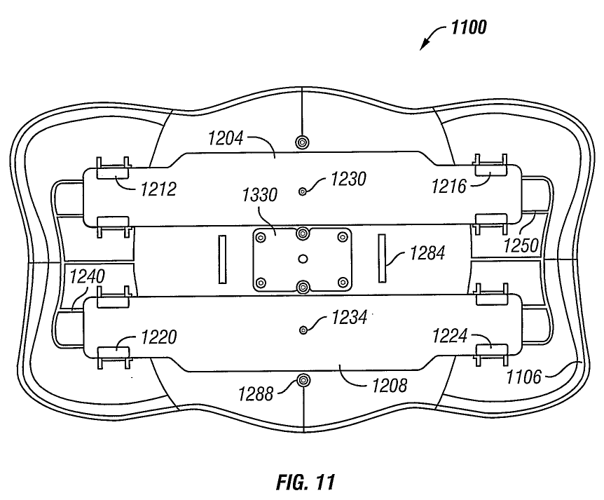

The flexible plastic member 1106 has an arch shape. A pair of elongate leaf springs 1204, 1208 are attached to the bottom surface of the body member 1106 using a pair of clips 1212, 1216, 1220, 1224 at both ends and a central locator pin 1230, 1234 in the center, as illustrated in FIG. 11. The clips and the pins are integrally formed with the body member 1106 and extend downwardly from the lower surface thereof. Further, ribs 1240, 1250 are provided to reduce friction between the leaf springs 1204, 1208 and the bottom surface of the body member 1106. The leaf springs 1204, 1208 are formed preferably from stainless steel or other type of spring steel. Instead of providing two leaf springs, a larger leaf spring with a central hole can be used. Further, instead of using one or more separate springs, the body member itself can provide the spring return action, such as by making the body member out of an engineered plastic.

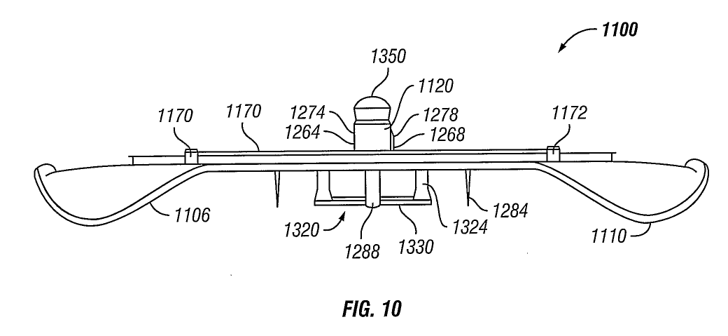

The post assembly 1120 includes a generally cylindrical member 1240 having a flat top edge and a hollow interior. Formed on opposite sides thereof are elongate flexing ribs 1264, 1268 attached at their tops and bottoms but flexible in the center portions. The ribs 1264, 1268 have nibs 1274, 1278 at central locations extending outwardly. The nibs 1274, 1278 define a disc support surface when a disc 1170 is placed in an initial rest position on the post assembly 1120 as shown in FIG. 10.

When the user then pushes down on the disc 1170, the ribs 1264, 1268 and especially the nibs 1274, 1278 are pushed and flexed inwardly generally beyond the circumference of the cylindrical portion, thereby allowing the disc to be pressed down as shown in FIG. 10 against the image holding layer. As the disc 1170 initially contacts the image holding layer of the image transfer sheet 1130 and is further pressed down manually by the user, the disc 1170 is pressed towards the support surface of the applicator 1100. The disc gradually contacts further outwardly disposed portions of the image transfer sheet 1130. This gradual application of the image holding layer aids the image holding layer in adhering in a crease-free and bubble-free way to the disc. The fully pressed-down condition of the applicator 1100 is shown in FIG. 10. The fin and post stopper members 1284, 1288 engage the surface on which the applicator 1100 rests to define a fully pressed position of the applicator 1100.

The applicator 1100 can also be uniquely and readily adapted for use with labels having any size of opening. For labels having a large central opening, a centering means for centering the larger hole concentrically about the narrower post assembly is needed. The present invention provides such a unique structure (a four-prong locator assembly shown generally at 1320 in FIG. 10) which the user can move from an inoperative, out-of-the-way position in which small hole opening image transfer sheets can be used, to an operative position wherein the structure is in place to define a large hole label locator system.

The locator assembly 1320 includes a plurality of posts 1324. Although the preferred number of posts 1324 is four or three or two, more than four posts can be used. Other structures aside from posts, such as arcuate members, can be used. These posts 1324 are interconnected together with a bottom plate 1330 as shown in FIGS. 11, for example. In other words, the four posts 1324, connected together by the bottom plate 1330, move together up and down through respective openings in the body member 1106. A post 1340 is connected to the top surface of the plate 1330 and extends through a central opening in the body member 1106 and up through the center of the post assembly 1120. And a knob 1350 is attached to the top of the post 1340. A knob 1350 provides a handle by which the user can pull the post 1340 up and thereby the four locator posts 1324. The four raised locator posts 1324 allow the applicator 1100 to center and accommodate a larger opening label 1190. Alternatively, this label can also be provided with the no- touch tabs as described for the small hole label. The label, if it has tabs, can similarly be held in place by the four pins 1170, 1172, engaged in the tab side notches.

The label applicator 1100 is typically manufactured and assembled by the manufacturer. For one embodiment of the application, the following components are delivered to or made by the manufacturer: the applicator body member 1106, the four prong locator assembly 1320, the knob 1350, the two leaf springs 1204, 1208, and the foam pad 1136. The springs 1204, 1208 are delivered pre-cut and shaped to a curve. And the foam pad 1136 is preferably delivered in sheets with pads pre-cut and the logo printed on them and an adhesive layer having a protective silicone liner. The springs 1204, 1208 are slid under their respective clips 1212, 1220 at one end thereof until they can be pushed no further. The applicator body member 1106 is then bent, and the springs 1204, 1208 are slid back under the clips 1216, 1224 at the other end of the body member. The springs 1204, 1208 are pushed in until the locator pins 1230, 1234 engage in the respective holes in the springs. The four-prong locator assembly 1320 is then pushed up through the holes in the applicator body member 1106. The knob 1350 is snapped on the top of the post 1340 of the prong locator assembly 1320. The liner is peeled from the foam pad 1136, and the foam pad is positioned in place, adhered on top of the applicator body member 1106. An embossed outline on the applicator body member 1106 acts as a guide for correctly positioning the foam pad 1136.

The consumer removes the assembled applicator 1100 as provided by the manufacturer from its box or other packaging (not shown). The image transfer sheet assemblies can be provided in sheets in the packaging and/or in separate packages. The user will design, using software on his computer, the desired indicia to be printed on the labels. The sheets are then passed through an ink jet printer, or are written upon with a liquid ink pen, or otherwise printed on with text and/or graphics. The printed image transfer sheet will then be separated off of the sheet by the user, who grasps the tabs to avoid touching the printed image that will be transferred to the disc.

The image transfer sheets may have a natural curl to them, and one embodiment of an applicator described herein takes advantage of that curl by providing a curved support surface on the applicator 1100 for the labels. The present invention also provides an advantage in that the pins 1170, 1172 grip the notches 1180, 1184 in the no-touch tabs and hold the image transfer sheet snugly against the support surface of the applicator. The image transfer sheet 1130 is placed with the image holding layer up on the curved foam pad 1 136 of the applicator 1100 using the locator pins 11 70, 1172 to locate and hold it in position.

The body member, when not pressed down, preferably has a height of 2.875 inches and has a footprint having a width of 5.25 inches and a length of 8.125 inches. When in a compressed label application position has a height of 1.5 inches and a footprint of the same width as when in the rest position but a longer length of 9.125 inches. While small hole image transfer sheets can have a central hole diameter of 0.604 inch, the hole image transfer sheets can have a central hole diameter of 1.625 inches. Dimensions other than those set forth above as would be apparent to those skilled in the art are within the scope of this invention, as are different configurations and materials.

For example, the applicator can instead of the above-described post assembly use a plunger arrangement. However, it is intended that all such variations not departing from the spirit of the invention be considered as within the scope thereof.

The foregoing has presented various alternative embodiments of image transfer sheets and ways of applying images to various objects. It should be understood, however, that the foregoing embodiments are presented for purposes of example only. The invention itself is broader than the specific examples that are used herein in order to illustrate applications of the invention. Various alternatives may be implemented within the scope of the invention. For example, adhesive transfer sheets may be pre-printed prior to sale to the end user. The end user may then use the pre-printed image transfer sheets for a specific purpose, such as for applying a sunlight-reducing film to a window.

As another variation, the image transfer sheet may be coated with ink-receptive coating in only specific locations. For instance, a pattern of label-sized areas of transferable ink-receptive coating may be coated onto a sheet, with a boundary about each label of a non-transferable coating. Consequently, after printing, only label-shaped sections will transfer onto the substrate. In this manner, specific portions of the image transfer sheet may be made transferable after printing, with other areas non-transferable, to define a transferable pattern or to limit the size or shape of the areas that will transfer.

To improve image transfer, and particularly to improve separation of the printed image from the backing sheet when the image is transferred, the image holding layer may be printed upon such that boundaries where the image is to be separated from the sheet are printed upon more heavily than in other areas. For example, extra ink may be printed about the perimeter of the image where the image is to separate from the backing sheet. This step of printing additional ink may be accomplished by means of software, such as by adjusting printing software known in the art to instruct the printer to print more heavily about the perimeter of the image.

As previously mentioned, image transfer sheets of this invention are not limited to labels that transfer from heat and/or pressure. They may alternatively employ water-activated adhesives that may not be particularly heat and/or pressure sensitive. In this regard, Patent Cooperation Treaty Application No. PCT/US99/09737 (International Publication No. WO 99/56682), which describes several different sheet structures and formulations for adhesive image transfer applications, is herein incorporated by reference. Additional disclosure is provided by U.S. Pat. No. 6,080,261, which is entitled “Adhesive Image Transfer Technique” and which issued on Jun. 27, 2000 and is also herein incorporated in its entirety . Several of the sheet structures disclosed in these two references include a water-activated polymer layer that becomes tacky when imaged with a water-based ink, and that are suitable for use in labeling discs and a wide variety of other objects. Consequently, the present invention extends to sheet structures that are coated with water-activated adhesives, as well as to structures that are coated with heat and/or pressure-activated adhesives.

Consequently, the present invention is not limited to the specific embodiments that are illustrated in this Detailed Description. The meets and bounds of the invention are to be determined from the wording of the following claims alone.

It should be noted that with the water-activated adhesive embodiments, the image transfer normally takes place shortly after printing. Otherwise, the adhesive image transfer layer will dry and become non-tacky. Consequently, the heat and/or pressure sensitive adhesive embodiments discussed previously are better suited than strictly water-activated or liquid ink activated polymers for applications in which the image is not to be applied and transferred immediately after printing.

It should also be noted that the various commercial products that are cited above are for illustrative purposes only, and that substitutes from other manufacturers may, of course, be used. Furthermore, the present invention is not limited to the specific compositions presented above, which are given only as examples of the coatings employed in the present invention.

As other alternatives, users may indulge in a new form of digital art wherein they could print various images onto the facestock-less constructions, according to the teachings of the present invention, as overlay one transferred image over another, in order to make a collage. These transferred images may be placed upon various materials and surfaces such as paper, walls, window and tile for example.

Additionally, tape constructions may also be made according to the disclosed teachings of the present invention, that may be utilized for highlighting or correction purposes. These constructions may be provided in various colors, including white, and/or opacity in tape form and placed adhesive layer down upon the area to highlight, for example text in a book, and the liner or backing rubbed to activate the image holding polymer layer to a tacky state, then removing the liner or backing to leave the printed (and possibly color-printed) layer behind. Once again, it is to be understood that the embodiments of the invention disclosed herein are illustrative of the principles of the invention and accordingly the present invention is not limited to that precisely shown and described in the present specification.

We claim:

1. A method for transferring a printed image to a substrate comprising the steps of:
preparing an image transfer assembly comprising in succession a backing layer, a release layer, a water repelling layer and an ink-absorbing, image holding polymer layer;
applying ink to the image holding polymer;
positioning the image transfer assembly onto a substrate;
activating the image holding layer to a tacky state;
adhering at least a portion of the image holding layer and the water-repelling layer to the substrate; and
removing the backing layer from the image holding layer and the water-repelling layer.

2. A method for transferring a printed image to a substrate as defined in claim 1, wherein the disc labeling assembly is prepared such that the release layer is interposed in between the water repelling layer and the backing layer, and the water repelling layer is interposed in between the release layer and the image holding layer.

3. A method as defined in claim 1, wherein the step of activating the image holding layer to a tacky state comprises rubbing the backing sheet.

4. A method as defined in claim 1, wherein the step of activating the image holding layer to a tacky state comprises wetting at least a portion of the ink-absorbing layer with ink.

5. A method as defined in claim 1, wherein the step of positioning the construction onto a surface comprises positioning the construction onto a post of a labeling apparatus.

6. A method as defined in claim 1, wherein the step of preparing an image transfer assembly comprising in succession a backing layer, a release layer, a water repelling layer and an ink-absorbing, image holding polymer layer further includes providing an outer surface of the image holding polymer with channels for air egress.

7. A method as defined in claim 1, wherein the image holding polymer constitutes means for holding an image printed with aqueous ink.

8. A method of labeling a disc comprising the steps of:
preparing an adhesive image transfer sheet comprising at least one ink-absorbing polymer layer and a backing sheet;
printing on the ink-retaining layer with ink;
adhering the ink-retaining polymer layer to the surface of a disc; and
removing the backing sheet from at least a portion of the ink retaining polymer layer after the ink retaining layer has been adhered to the disc.

9. A method as described in claim 8 wherein the step of preparing an adhesive image transfer sheet comprises preparing a backing sheet, a water-repellent layer on said backing sheet, and an ink-retaining polymer layer on said backing sheet.

10. A method as described in claim 9, wherein the image transfer sheet further comprises a release layer between the backing sheet and the water-repellent layer.

11. A method as described in claim 8, wherein the step of adhering the ink-retaining layer to the surface of the disc comprises applying the ink-retaining layer to the disc and rubbing the backing sheet.

12. A method as described in claim 8 wherein the step of adhering the ink-retaining layer to the surface of the disc comprises activating at least a portion of the ink-retaining layer with ink to a tacky state and then applying the ink-retaining layer to the surface of the disc.

13. A method as described in claim 12 wherein the ink is a water-based ink.

14. A method as described in claim 8 wherein the step of removing the backing sheet from the image holding layer after the image holding layer has been adhered to the disc comprises removing the backing sheet from only a portion of the ink retaining layer that has been activated to a tacky state, with a portion of the ink retaining layer that has not been activated to a tacky state remaining on the backing sheet.

15. A method as described in claim 8 wherein the method further comprises the step of printing an image onto the ink-retaining layer with an ink jet printer.

16. A method as described in claim 8 wherein the printer is an ink jet printer.

17. A method as described in claim 8 wherein the printer is a pen and the printing is performed by hand.

18. A method as described in claim 8, wherein the step of preparing an adhesive image transfer sheet comprises preparing a disc label with a positioning portion and a generally circular portion having an ink-absorbing layer.

19. A method as described in claim 18, wherein the generally circular portion of the disc label further comprises a water-resisting layer between the backing sheet and the image holding layer.

20. An assembly for applying an image onto an optical media disc having a spindle aperture comprising:
a flexible sheet of material having a first major surface and a second major surface opposite thereto, said sheet being divided into an image transfer portion and a centering portion adjacent thereto, said centering portion being connected to said image transfer portion;
said image transfer portion defining an aperture therein for registration with the spindle aperture of an optical media disc when said label is properly mounted on said optical media disc, the second major face of said sheet in said image transfer portion carrying an ink-absorbing layer;
said centering portion having an engagement edge on a side thereof remote from said image transfer portion;
said image transfer portion comprising a backing layer and a removable ink-absorbing polymer layer.

21. An assembly as defined in claim 20, wherein the removable ink-absorbing layer comprises a film derived from an acrylic polymer emulsion.

22. An assembly as defined in claim 20, wherein the image transfer portion further comprises a release layer between said ink-absorbing layer and said release layer.

23. An assembly as defined in claim 20, wherein the image transfer portion further comprises a water-repelling layer between said backing layer and said ink-absorbing layer.

24. An assembly as defined in claim 20, wherein the water-repelling layer comprises a film derived from an acrylic-based emulsion.

25. An assembly as defined in claim 20, wherein the image transfer portion further comprises a release layer on the backing layer, and a water-repelling layer between the release layer and the ink-absorbing layer.

26. An assembly as defined in claim 25, wherein the ink-absorbing layer comprises a film derived from an acrylic polymer emulsion and the water-repelling layer comprises an acrylic-based emulsion.

27. An assembly as defined in claim 20, wherein the ink-absorbing layer is activatable to a tacky state by the application of pressure.

28. An assembly as defined in claim 20, wherein the ink-absorbing layer is activatable to a tacky state by light manual rubbing.

29. An assembly as defined in claim 20, wherein the ink-absorbing layer is water-activatable to a tacky state.

30. A method of labeling an optical media disc comprising the steps of:
printing an image into an ink absorbing polymer layer;
activating the ink absorbing polymer layer to a tacky state with heat;
after printing an image into an ink absorbing layer, transferring the ink absorbing polymer layer onto an optical media disc to label the optical media disc.

31. A sheet for transferring an image to a substrate, constituting:
a backing sheet; and
an image retaining layer on the backing sheet that is initially not tacky but that is activatable to a tacky state, the image retaining layer comprising a polymer that is activatable to a tacky state when exposed to water and that is also activatable to a tacky state with light, manual rubbing on the backing sheet when the sheet is placed against a substrate such that the image retaining layer is against a surface of the substrate.

32. A sheet as defined in claim 31, wherein the image retaining layer further comprises an additive that reduces surface tackiness of said polymer.

33. A sheet as defined in claim 32, wherein said additive is a quaternary amine type of polymer.

34. A sheet as defined in claim 31, wherein the surface of the image retaining layer is patterned to allow air egress as the image holding layer is adhered to a substrate.

35. A sheet as defined in claim 31, wherein the image retaining layer further comprises a pigment.

36. A sheet as defined in claim 31, wherein the sheet comprises a circular portion corresponding to the shape of an optical media disc and at least one tab immediately adjacent to the circular portion.

37. A sheet as defined in claim 31, wherein the sheet further comprises a water-resistant layer in between the backing sheet and the image retaining layer.

38. A method of printing an image onto an image transfer sheet and transferring the image to a substrate, the method comprising the steps of:
providing a sheet as defined in claim 31;
printing an image onto the image retaining layer with an inkjet printer;
placing a surface of the adhesive retaining layer onto a substrate;
after placing a surface of the adhesive retaining layer onto a substrate, rubbing on the backing sheet to activate at least a portion of the adhesive; and
removing the backing sheet.

39. A method of image transfer as defined in claim 38, further comprising the step of allowing the printed image to dry after the printing step before placing a surface of the adhesive retaining layer onto the substrate.

40. A method of reducing transmission of electromagnetic radiation through a window comprising the steps of:
providing an image transfer sheet as defined in any of claims 31 - 35 or 37;
placing the image transfer sheet against a window, with the image retaining layer against a surface of the window;
adhering the image retaining layer to the window; and
removing the backing sheet.

41. A method as defined in claim 40, wherein the method further comprises the step of cutting the image transfer sheet to fit the sheet to at least a portion of the window.

42. A method as defined in claim 40, wherein the step of adhering the image retaining layer to the window includes wetting the image retaining layer.

43. A method as defined in claim 40, wherein the step of adhering the image retaining layer to the window includes placing the sheet against the window, with the image retaining layer against a surface of the window, and rubbing the backing sheet.

44. A method as defined in claim 40, wherein the image retaining layer is printed upon prior to being adhered to the window.

45. A method as defined in claim 40, wherein the image retaining layer is not printed upon prior to being adhered to the window.
